(19) United States
(12) Patent Application Publication
(10) Pub. No.: US 2002/0079705 A1
(43) Pub. Date: Jun. 27, 2002

(54) Windpower generating apparatus

(76) Inventor: Benjamin P. Fowler, Houston, TX (US)

Correspondence Address: HARRISON & EGBERT, 412 MAIN STREET, 7TH FLOOR, HOUSTON, TX, 77002, US

(21) Appl. No.: 09/748,094

(22) Filed: Dec. 27, 2000

(51) Int. Cl. F03D 9/00; H02P 9/04

(52) U.S. Cl. 290/55

(57) ABSTRACT

A windpower generating apparatus including a vertical support member, a first arm assembly rotatably mounted on the support member transverse to the support member, a second arm assembly rotatably mounted relative to the support member transverse to the support member, a first plurality of vane members pivotally affixed to the first arm assembly, and a second plurality of vane members pivotally affixed to the second arm assembly. The vane members are movable between an open position and a closed position relative to a wind direction. The first arm assembly extends transverse to the second arm assembly. An electrical generator is connected to one of the first and second arm assemblies for generating electrical energy relative to a speed of rotation of the arm assemblies about the vertical support member.

### TECHNICAL FIELD

The present invention relates to apparatus for generating electrical energy. More particularly, the present invention relates to apparatus for generating electrical energy from the action of wind. Furthermore, the present invention relates to devices for producing energy by rotating in response to the velocity of wind.

### BACKGROUND ART

The present invention relates in general to power generation devices, and, more in particular, to a wind-driven power generation device.

Windmills have been known since ancient times. These devices extract power from the wind. Usually, the power is used in driving pumps for irrigation or supplying electrical power in rural areas.

Some large scale wind turbines have been successful. One of these was the Smith-Flutnam wind turbine generator built in Vermont in the early 1940's. This system had a blade span of 175 feet and produced 1.25 megawatts of electricity in a 32 mile per hour wind. The unit was abandoned after a blade failure in favor of conventional electrical generating plants that were more cost effective at that time. With the increase in energy costs, the attractiveness of windpower has improved.

Recently consideration has been given to using windpower generators to supply electrical energy for sophisticated requirements. A host of problems, however, attend such an attempt. Wind is incredibly variable. Wind varies from geographical location to geographical location and from season to season. Some areas are blessed with a considerable amount of wind. Others are wind poor. Wind velocities and direction fluctuate broadly in short periods of time. In areas where considerable wind exists, the diurnal changes in wind velocity can vary from almost nothing to a considerable value. A mean wind speed is attendant with frequent gusts and lulls. The wind velocity varies considerably in elevation close to the ground.

The lack of constant wind from a constant direction makes power generation for electrical utility purposes seem difficult. Electrical power for utilities must be of extremely high quality. By way of example, a utility generated power must be held extremely close to 60 cycles per second. If it is not, the power is totally unsatisfactory. This means that in a wind generating system some means must exist to assure constant power generation. Synchronous generators can obtain this end, but they must be powered by a system that supplies considerable power for all wind conditions if overall efficiencies are to be opened. The generators cannot be permitted to devote energy either to slowing down the drive or speeding up the drive. The generators motoring the drive system can also place unusual stresses on the roots of the propeller blades.

A considerable problem exists when the wind blows only in gusts. When the wind speed is minimal, typical windpower generating systems will simply shut down rather than cause the wind mill blades to spin at a very slow and inefficient speed. As such, it is desirable to maintain the blades in a spinning motion for as long as possible following a wind gust.

It is an object of the present invention to provide an apparatus for generating electrical energy relative to the action of wind.

It is another object of the present invention to provide a windpowered generator apparatus which is responsive to the action of wind in an optimal and efficient manner.

It is another object of the present invention to provide a windpowered generator apparatus which utilizes mechanical energy for facilitating the response to wind action.

These and other objects and advantages of the present invention will become apparent from a reading of the attached specification and appended claims.

### SUMMARY OF THE INVENTION

The present invention is a windpower generator apparatus comprising a vertical support member, a first arm assembly rotatably mounted relative to the vertical support member so as to be transverse to the support member, a second arm assembly rotatably mounted relative to the vertical support member so as to be transverse to the support member and transverse to the first arm assembly, a first plurality of vane members pivotally affixed to the first arm assembly, and a second plurality of vane members pivotally affixed to the second arm assembly. Each of the, first and second plurality of vane members is movable between an open position and a closed position relative to a wind direction.

In the present invention, each of the first and second arm assemblies includes a first strut and a second strut mounted in parallel relationship to the first strut. The first plurality of vane members has a first pivot point connected to the first strut and a second pivot point connected to the second strut. A bearing member is connected to the first strut and rotatably mounted to the vertical support member and another bearing member is connected to the second strut and rotatably mounted on the vertical support member. A third strut is connected to the first bearing member and extends outwardly therefrom in longitudinal alignment with the first strut. A fourth strut is connected to the second bearing member and extends outwardly therefrom in longitudinal alignment with the second strut. A first panel is affixed to an end of the first and second struts. This first panel extends transverse to the first and second struts. A second panel is affixed to an end of the third and fourth struts. The second panel extends transverse to the third and fourth struts. The second panel is in parallel planar relationship to the first panel. Each of the first and second panels is fixedly and non-pivotally mounted onto the respective struts.

Each of the vane members is in overlapping relationship to an adjacent vane when in the closed position. Each of the vane members is in parallel planar relationship to each other in the open position. The vane members between a pair of struts have a line connected to an adjacent vane such that each of the vane members between the struts moves correspondingly. The line is affixed to a comer of each vane opposite the respective pivot point.

An electrical energy generation means is connected to the arm assemblies. The electrical energy generation means serves to generate electricity relative to a speed of rotation of the first and second arm assemblies about the vertical support member. The electrical energy generation means includes a gear box mounted on the vertical support member and being connected to at least one of the first and second arm assemblies, a flywheel alternator connected to the gear box so as to generate electrical energy, and a battery electrically connected to the flywheel alternator.

### BRIEF DESCRIPTION OF THE DRAWINGS

FIG. 1 is a perspective view showing the windpower generating apparatus of the present invention.

FIG. 2 is a bottom view showing the windpower generating apparatus of the present invention relative to the force of wind.

FIG. 3 is a diagrammatic illustration of the electrical generating means of the present invention.

### DETAILED DESCRIPTION OF THE PRESENT INVENTION

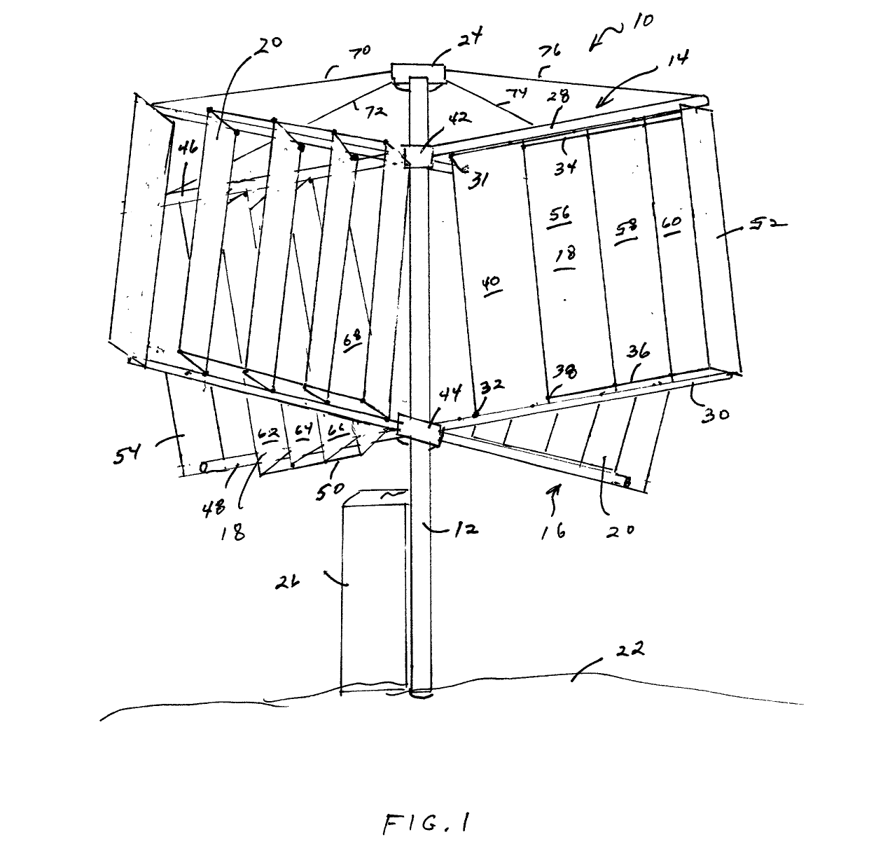

Referring to FIG. 1, there is shown the windpower generating apparatus 10 in accordance with the teachings of the present invention. The windpower generating apparatus 10 includes a vertical support member 12, a first arm assembly 14 rotatably mounted on the vertical support member 12 so as to extend transverse to the longitudinal axis of the vertical support member 12. A second arm assembly 16 is rotatably mounted on the vertical support member 12 so as to extend transverse to the support member 12. The second arm assembly 16 is transverse to the first arm assembly 14. A plurality of vane members 18 are pivotally affixed to the first arm assembly 14. A plurality of vane members 20 are pivotally affixed to the second arm assembly 16. As can be seen in FIG. 1, each of the vane members 18 and 20 are movable between an open position and a closed position relative to a wind direction.

The vertical support member 12 can be a tubular pole which is affixed within the earth 22. The vertical support member 12 extends vertically upwardly therefrom. The vertical support member 12 supports a gear box 24 at its upper end opposite the earth 22. The gear box 24 is connected to a flywheel alternator so that electrical energy can be generated by the rotation of the arm assemblies 14 and 16 relative to the vertical support member 12. A battery 26 is positioned on the earth 22 adjacent to the bottom of the vertical support member 12. The battery 26 is electrically connected to the flywheel alternator associated with the gear box 24. The electrical lines can extend from the gear box 24 through the interior of the vertical support member 12.

In contrast to the prior art, windpower generating systems, in the present invention, the arm assemblies rotate around a vertical support member. A typical windpower generating apparatus has a plurality of vane members which rotate around a horizontal axis pivotally attached to a vertical support.

The first arm assembly 14 includes a first strut 28 and a second strut 30 mounted in parallel relationship to each other. As can be seen, some of the first plurality of vane members 18 have a first pivot point 31 connected to the first strut 28 and a second pivot point 32 connected to the second strut 30. Each of the vane members 18 will open and close relative to the action of the wind against these vane members 18. In FIG. 1, it can be seen that the vane members associated with the struts 28 and 30 are in their closed position. A line 34 extends between the edges of each of the vane members 18 opposite the pivot point 31. Another line 36 extends from the edge 38 of vane member 40 to the respective edges of the other vane members associated with the first plurality of vane members 18. As such, each of the first plurality of vane members 18 between the struts 28 and 30 will open and close correspondingly.

The first strut 28 is connected to a first bearing member 42. The second strut 30 is connected to a second bearing member 44. The bearing members 42 and 44 allow the first arm assembly 14 to rotate freely and easily around the vertical support member 12. As can be seen in FIG. 1, a third strut 46 is connected to the first bearing member 42 and extends outwardly therefrom in longitudinal alignment with the first strut 28. A fourth strut 48 is connected to the second bearing member 44 and extends outwardly therefrom in longitudinal alignment with the second strut 30. The rest of the first plurality of vane members 18 extends between the third strut 46 and the fourth strut 48. Each of these plurality of vane members 18 has a pivot point on each of the respective struts 46 and 48 so that the respective vane members can open and close relative to the action of the wind thereon. As can be seen in FIG. 1, a line 50 connects the outer edges of the respective vane members 18 so that the vane members 18 can open and close correspondingly.

In FIG. 1, a first panel 52 is affixed to an end of the first strut 28 and the second strut 30 so as to extend transverse to the plane formed between the first strut 28 and the second strut 30. Similarly, a second panel 54 is affixed to the ends of the third strut 46 and the fourth strut 48 so as to extend transverse to a plane formed between the third strut 46 and the fourth strut 48. The first panel 52 is in parallel planar relationship to the second panel 54. It has been found that this transverse relationship between the plane of the respective struts of the arm assembly 14 increases the power associated with the rotation of the arm assembly 14 around the vertical support member 12. The panels 52 and 54 are fixedly and non-pivotally mounted at the respective ends of the struts 28 and 30 opposite the vertical support member 12.

As can be seen in FIG. 1, the vanes 40, 56, 58 and 60 of the first plurality of vane members 18 are in overlapping relationship. In this arrangement, the vane members 40, 56, 58 and 60 will receive a maximum force of the wind impinging thereon. The first panel 52 will capture the force of the wind because of its orthogonal relationship to the overlapping vane members 40, 56, 58 and 60.

The second arm assembly 16 has a configuration identical to the first arm assembly 14 but extending transversely thereto. The second arm assembly 16 is also rotatably mounted to the vertical support member 12 through the use of bearings 42 and 44.

In FIG. 1, it can be seen that the vane members 62, 64, 66 and 68 are shown in their generally open position. Each of the vane members 62, 64, 66 and 68 has suitably pivoted to the open position because of the action of the wind direction. Since each of the vane members 62, 64, 66 and 68 of the plurality of vane members 18 is in the open position, the vane members between the struts 46 and 48 will pass with little resistance through the wind. Experiments with the present invention have shown that this configuration of vane members maximizes the amount of power generated through the windpower generating apparatus 10.

Lines 70, 72, 74 and 76 extend outwardly from the gear box 24 to the respective ends of the various strut members. As such, the windpower generating apparatus 10 can maintain its arm assemblies 14 and 16 in their desired orientation and to transfer a maximum amount of power from the outer periphery of each of the arm assemblies 14 and 16 to the gear box 26.

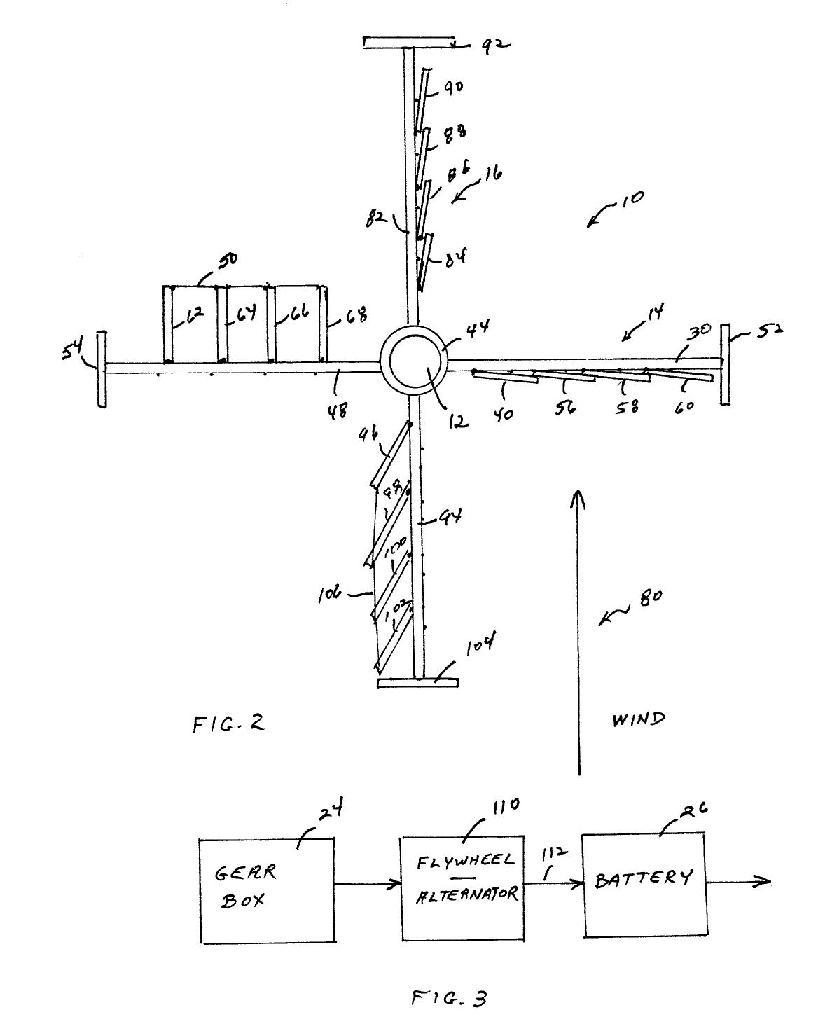

FIG. 2 shows the windpower generating apparatus 10 in its desired arrangement relative to the wind direction 80. The wind direction 80 is illustrated by the arrow in FIG. 2.

The first arm assembly 14 is illustrated as having the vane members 40,56,58 and 60 in their closed position. The first panel 52 is arranged perpendicular to the strut 30. For the purposes of illustration, the line connecting the outer edges of each of the vane members 40, 56, 58 and 60 has been omitted in FIG. 2. The strut 30 is illustrated as extending outwardly from the bearing member 44 associated with the vertical support member 12. Since the vane members 40, 56, 58 and 60 are in overlapping relationship, the wind 80 will exert a maximum force thereagainst so as to rotate the windpower generating apparatus around the vertical support member 12. The strut 82 associated with the second arm assembly 16 will have its respective vane members 84, 86, 88 and 90 remaining in the closed position. A panel 92 is illustrated as extending perpendicular to the strut 82 associated with the second arm assembly 16. It can be seen that the second arm assembly 16 extends in perpendicular relationship to the first arm assembly 14.

As the arm assemblies 14 and 16 rotate relative to the wind impinging thereon, the vane members 62, 64, 66 and 68 pivot outwardly about their respective pivot points associated with the strut 48. It can be seen that the line 50 connects the outer edges of each of the vane members 62, 64, 66 and 68 so that these vane members will pivot outwardly correspondingly. The panel 54 is illustrated as in transverse relationship to the strut 48. In this “open” arrangement, the wind 80 will pass therethrough so that the strut 48 will freely rotate to a desired position.

The strut 94 associated with the second arm assembly 16 is shown in its position facing the wind 80. The respective vane members 96, 98, 100 and 102 start to move toward their closed position. The action of the panel 104 slightly blocks the wind flow thereto so that these vane members 96, 98, 100 and 102 will start to close. A line 106 connects the outer edges of the vane members 96, 98, 100 and 102 so that the respective vane members will open and close correspondingly.

In the present invention, eight vane members are associated with each arm assembly. This is not to be construed as limitative thereof. Any number of van members or shape of vane members can be used in association with the present invention.

FIG. 3 shows the manner in which the present invention generates electricity. The gear box 24 will receive the rotating action of the arm assemblies 14 and 16. This gearbox 24 will rotate the flywheel associated with the alternator 110. As such, the alternator 110 will generate electrical energy. A line 112 will transmit the electrical energy to the battery 26 for storage. At such time as it is necessary to use the power from the battery 26, a suitable inverter can receive the energy from the battery 26 and to convert the energy into 120/240 volts AC. This energy can be used in a standard way by any commercial, residential, or industrial establishment.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. A windpower generating apparatus comprising:
a vertical support member;
a first arm assembly rotatably mounted on said support member so as to be transverse to said support member;
a second arm assembly rotatably mounted on said support member so as to be transverse to said support member, said second arm assembly being transverse to said first arm assembly;
a first plurality of vane members pivotally affixed to said first arm assembly; and
a second plurality of vane members pivotally affixed to said second arm assembly, each of said first and second plurality of vane members movable between an open position and a closed position relative to a wind direction.

2. The apparatus of claim 1, said first arm assembly comprising:
a first strut; and
a second strut mounted in parallel relation to said first strut, said first plurality of vane members having a first pivot point connected to said first strut and a second pivot point connected to said second strut.

3. The apparatus of claim 2, further comprising:
a first bearing member connected to said first strut and rotatably mounted on said vertical support member; and
a second bearing member connected to said second strut and rotatably mounted on said vertical support member.

4. The apparatus of claim 3, said first arm assembly further comprising:
a third strut connected to said first bearing member and extending outwardly therefrom in longitudinal alignment with said first strut; and
a fourth strut connected to said second bearing member and extending outwardly therefrom in longitudinal alignment with said second strut.

5. The apparatus of claim 4, said first arm assembly further comprising:
a first panel affixed to an end of said first and second struts, said first panel extending transverse to said first and second struts.

6. The apparatus of claim 5, said first arm assembly further comprising:
a second panel affixed to an end of said third and fourth struts, said second panel extending transverse to said third and fourth struts, said second panel being in parallel planar relationship to said first panel.

7. The apparatus of claim 6, each of said first and second panels being fixedly and non-pivotally mounted onto the respective struts.

8. The apparatus of claim 1, each of said first plurality of vane members overlapping an adjacent vane in said closed position, each of said second plurality of vane members overlapping an adjacent vane in said closed position.

9. The apparatus of claim 1, each of said first and second pluralities of vane members being in parallel planar relationship in said open position.

10. The apparatus of claim 2, each vane of said first plurality of vane members having a line connected to an adjacent vane of said first plurality of vane members such that each vane of said first plurality of vane members between said first and second struts moves correspondingly with the adjacent vane between said open and closed positions.

11. The apparatus of claim 10, said line being affixed to a corner of each vane opposite the respective pivot point.

12. The apparatus of claim 1, further comprising:
electrical energy generation means connected to said first and second arm assemblies, said electrical energy generation means for generating electricity relative to a speed of rotation of said first and second arm assemblies about said vertical support member.

13. The apparatus of claim 12, said electrical energy generation means comprising:
a gear box mounted on said vertical support member and having a connector extending to at least one of said first and second arm assemblies;
a flywheel alternator connected to said gear box, said flywheel alternator generating electrical energy; and
a battery electrically connected to said flywheel alternator.

14. A windpower generating apparatus comprising:
a vertical support member;
a first strut rotatably mounted relative to said vertical support member;
a second strut rotatably mounted relative to said vertical support member in generally coplanar relationship to said first strut;
a third strut rotatably mounted relative to said vertical support member in generally longitudinal alignment with said first strut;
a fourth strut rotatably mounted relative to said vertical support member in generally longitudinal alignment with said second strut, each of said first strut and said second strut and said third strut and said fourth strut extending outwardly generally transverse to a longitudinal axis of said vertical support member;
a first vane member pivotally mounted between said first strut and said second strut, said first vane member movable between an open position and a closed position; and
a second vane member pivotally mounted between said third strut and said fourth strut, said second vane member movable between an open and closed position.

15. The apparatus of claim 14, said first vane member comprising:
a first vane having an edge pivotally connected to said first and second strut; and
a second vane having an edge pivotally connected to said first and second struts, said first vane overlapping said second vane when in said closed position.

16. The apparatus of claim 15, said first vane member comprising:
a line connected to an opposite edge of each of said first and second vanes such that said first and second vanes move between the open and closed positions correspondingly.

17. The apparatus of claim 14, each of said first and second vane members movable between the open and closed positions relative to a wind direction.

18. The apparatus of claim 14, further comprising:
a first panel non-pivotally affixed to an end of said first and second struts; and
a second panel non-pivotally affixed to an end of said third and fourth struts.

19. The apparatus of claim 18, said first panel having a planar surface extending transverse to a plane formed between said first and second struts, said second panel having a planar surface extending transverse to a plane formed between said third and fourth struts, said first panel being in generally planar parallel relationship to said second panel.

20. The apparatus of claim 14, further comprising:
electrical energy generation means connected to at least one of said first strut, said second strut, said third strut and said fourth strut, said electrical energy generation means for generating electricity relative to a speed of rotation of the respective struts about the vertical support member.
